(19) United States
(12) Patent Application Publication
(10) Pub. No.: US 2023/0157335 A1
(43) Pub. Date: May 25, 2023

(54) MANUFACTURING METHOD AND STRUCTURE OF PEARL TAPIOCA DICES

(71) Applicant: SHU SHIN BOU CO., LTD., TAOYUAN CITY (TW)

(72) Inventor: Chin-I WEN, Taoyuan City (TW)

(21) Appl. No.: 17/859,016

(22) Filed: Jul. 7, 2022

(30) Foreign Application Priority Data
Nov. 22, 2021 (TW) 110143335

(51) Int. Cl. A23L 19/10; A23L 29/212; A23L 33/105; A23L 7/10

(52) U.S. Cl. CPC A23L 19/11; A23L 29/212; A23L 33/105; A23L 7/10

(57) ABSTRACT

A manufacturing method and structure of pearl tapioca dices is first mixing glutinous rice flour, modified starch, water, maltose and other ingredients with granulated sugar, brown sugar, matcha or strawberry, mango, pineapple or other fruit additives; steaming them and pressing them into a sheet blank; cutting the sheet blank into squire strip blanks; then cutting the strip blanks into squares of appropriate size to complete the square pearl tapioca dices of different flavors. The pearl tapioca dice is convenient for preservation and convenient to be made into various pearl drinks.

### (a) TECHNICAL FIELD OF THE INVENTION

The present invention relates to a manufacturing method and structure of peal tapioca dices, and more particularly a manufacturing method and structure of pearl tapioca dices convenient for preservation and convenient to be prepared into various pearl tapioca beverages when eaten.

### (b) DESCRIPTION OF THE PRIOR ART

In recent years, Taiwan's chain hand-shaking beverage industry is quite developed and welcomed by consumers, especially pearl milk tea, which is popular all over the world. The ingredients of pearl milk tea mainly include pearl tapioca balls, milk tea, matcha, fruit tea or other tea, and syrup. The traditional way of making pearl tapioca balls is to first make raw pearl tapiocas, then boil them into cooked pearl tapioca balls after a certain period of time, and finally cool them with ice water, so as to become edible, chewy and elastic cooked pearl tapioca balls.

If the above pearl tapiocas cannot be eaten within a certain period of time, if it is placed for a long time or is stored in a refrigerator, they will be no longer chewy and elastic due to the aging and hardening of starch, and therefore completely lose their texture. Therefore, although pearl tapioca drinks are delicious, the added pearl tapioca balls have the problem of preservation, and the difficulty of preservation also increases the cost of operation, which is also a problem for the hand shaking beverage industry.

### SUMMARY OF THE INVENTION

The main object of the present invention is to provide a manufacturing method and structure of pearl tapioca dices, allowing manufactured pearl tapioca dices to be easily preserved, and to be convenient for making various pearl tapioca drinks when eaten.

To achieve the above object, the present invention proposes a manufacturing method and structure of pearl tapioca dices, mixing glutinous rice flour, modified starch, water, maltose and other ingredients with granulated sugar, brown sugar, matcha or strawberry, mango, pineapple or other fruit additives; steaming them and pressing them into a sheet blank; cutting the sheet blank into squire strip blanks; then cutting the strip blanks into squares of an appropriate size to complete the square pearl tapioca dices of different flavors. The pearl tapioca dices are convenient for preservation and convenient to be made into various pearl drinks.

In the above method, ingredients and additives have different proportions according to room temperature preservation formula and frozen preservation formula, i.e., the proportions of the ingredients and additives of room temperature preservation formula are different form the ones of frozen preservation formula, where the ingredients of room temperature preservation formula include 13-15% glutinous rice flour, 4-6% modified starch, 14-16% water, 49-51% maltose, and the additive is 15-7% granulated sugar.

In the above method, the proportions of the ingredients and additives of room temperature preservation formula are different form the ones of frozen preservation formula, where the ingredients of frozen preservation formula include 4-6% glutinous rice flour, 13-15% modified starch, 14-16% water, 49-51% maltose, and the additive is 15-7% granulated sugar.

In the method, t the additive may be 15-7% brown sugar, matcha or strawberry, mango, pineapple, durian, passion fruit and other fruit additives to form other different flavors, in addition to granulated sugar to form the original taste.

In the manufacturing method mentioned above, the pearl tapioca dices of room temperature preservation formula can be added to baked bread, pizza or other baked foods. The pearl tapioca dices of frozen preservation formula can be used as popsicles, ice cream, or added to different tea drinks such as milk tea, fruit tea, matcha or Thai milk tea, or cold drinks such as coffee.

The aforementioned pearl tapioca dice structure includes a solid body, and this solid body is a lump solid body made by mixing and kneading ingredients such as glutinous rice flour, modified starch, maltose and granulated sugar; at least one additive, which is made from at least any one of brown sugar, matcha or strawberry, mango, pineapple and other fruits, and the additive is uniformly mixed in the solid body structure in a certain proportion.

### BRIEF DESCRIPTION OF THE DRAWINGS

FIG. 1 is a manufacturing flow chart of the present invention;

FIG. 2 is a perspective view of the present invention;

FIG. 3 is a schematic view of the present invention in a packaging state; and

FIG. 4 is a perspective view of the present invention in a use state.

### DETAILED DESCRIPTION OF THE PREFERRED EMBODIMENTS

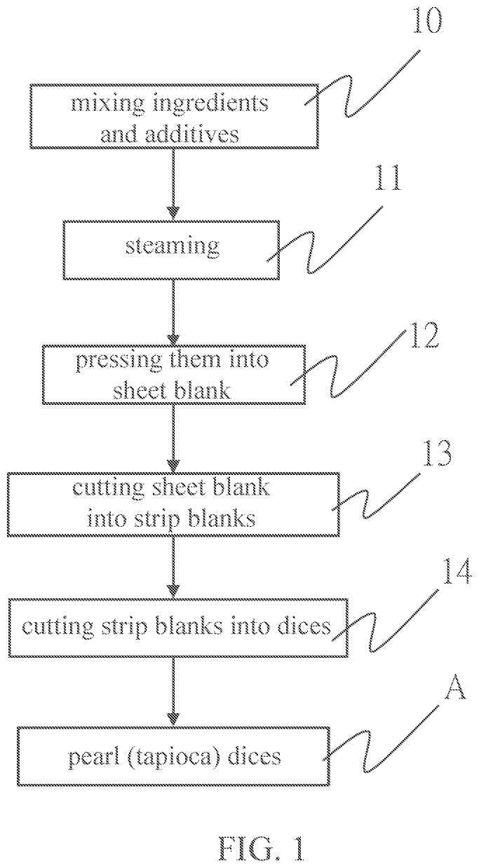

Referring to FIG. 1, a method for manufacturing pearl tapioca dices of the present invention includes the following steps:
1. mixing ingredients and additives of room temperature preservation or frozen preservation formula (step 10), the ingredients and additives having different proportions according to room temperature preservation formula and frozen preservation formula, where the ingredients of room temperature preservation formula include 13 to 15% glutinous rice flour, 4 to 6% modified starch, 14 to 16% water, and 49 to 51% maltose, and the additive thereof is 15 to 7% granulated sugar, and the ingredients of frozen preservation formula include 4 to 6% glutinous rice flour, 13 to 15% modified starch, 14 to 16% water, and 49 to 51% maltose, and the additive thereof is 15 to 7% granulated sugar additive, where the aforementioned additives, in addition to granulated sugar to form the original flavor, may be 15 to 7% brown sugar, matcha, coffee or fruit such as strawberry, mango, pineapple, durian, passion fruit to form other different flavors;
2. steaming the mixed ingredients and additives (step 11);
3. pressing the fully mixed and steamed ingredients and additives into a sheet blank, and sprinkling an appropriate amount of coating flour before and after pressing (step 12), so that the flour adheres to the surface and bottom of the blank to prevent sticking;
4. cutting the sheet blank into square strip blanks (step 13); and
5. cutting the strip blanks into square pieces of appropriate size, and shaking off part of the coating flour (step 14);
thus, completing the square pearl tapioca dices A with a different-flavor solid body.

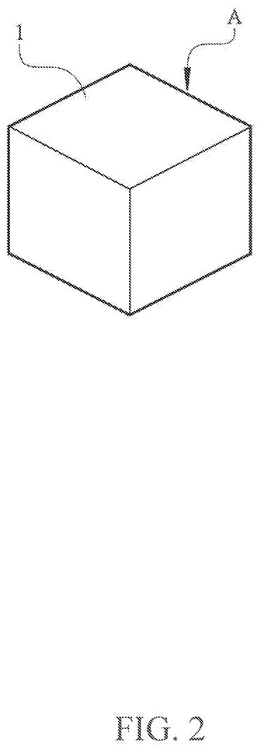

referring to FIG. 2, the square pearl tapioca dices each includes a solid body 1, which is a lump shaped solidified body formed by mixing and kneading the ingredients such as glutinous rice flour, modified starch, maltose and additives such as granulated sugar, brown sugar, matcha, or fruit such as strawberry, mango, or pineapple; the additive is uniformly mixed in the solid body 1 in a certain proportion to form a square-shaped pearl tapioca dice A.

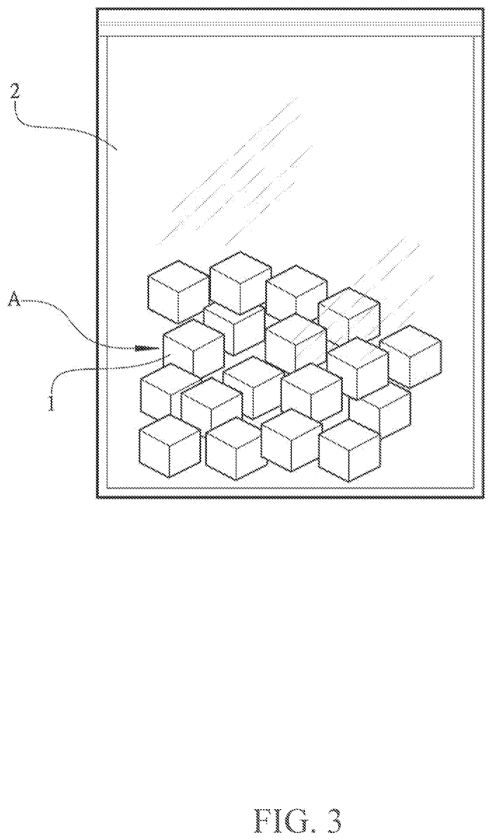

referring to FIG. 3, in the present invention, after completing the pearl tapioca dices A, an appropriate number of the pearl tapioca dices A can be packaged in a packaging bag 2 for use, where the pearl tapioca dices A of room temperature preservation formula can be added to baked bread, pizza or other baked goods and the pearl tapioca dices A of frozen preservation formula can be made into popsicles, ice creams, or added to different teas such as milk tea, fruit tea, matcha or Thai milk tea, or cold drinks such as coffee and milk.

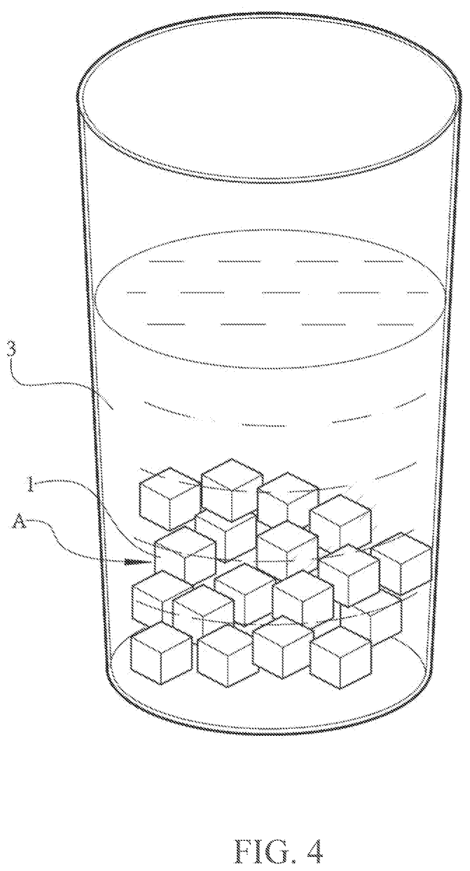

Referring to FIG. 4, in a use state of the present invention, the pearl tapioca dices A of room temperature formula can be added to baked bread, pizza or other baked goods. As for the pearl tapioca dices A of frozen preservation formula, after taking them out from the freezer, first wash the coated flour attached to the surfaces thereof, and then soak them in sugar water to prevent them from sticking to each other, so that when they are sold, the pearl tapioca dices soaked in sugar water are taken out and added to different tea drinks 3 such as milk tea, fruit tea, Matcha or Thai milk tea, or cold drinks 3 such as coffee. Thus, the production of tea drinks such as pearl milk tea is more convenient.

To sum up, the present invention uses the solid bodies such as glutinous rice flour, modified starch, and the different taste additives that are uniformly mixed in the solid body in a certain proportion to form a pearl tapioca dice structure, so that the pearl tapioca can be easily preserved, and can be conveniently made into various pearl tapioca drinks when eaten.

I claim:

1. A method for manufacturing pearl tapioca dices, comprising the following steps:
mixing ingredients and additives of room temperature preservation or frozen preservation formula, said ingredients and additives having different proportions according room temperature preservation formula and frozen preservation formula, wherein said ingredients of room temperature preservation formula comprise 13 to 15% glutinous rice flour, 4 to 6% modified starch, 14 to 16% water, and 49 to 51% maltose, and said additive thereof is 15 to 7% granulated sugar, and said ingredients of frozen preservation formula comprise 4 to 6% glutinous rice flour, 13 to 15% modified starch, 14 to 16% water, and 49 to 51% maltose, and said additive thereof is 15 to 7% granulated sugar additive;
steaming said mixed ingredients and additives;
pressing said fully mixed and steamed ingredients and additives into a sheet blank;
cutting said sheet blank into square strip blanks; and
cutting said strip blanks into square pieces of an appropriate size to completing square pearl tapioca dices.

2. The method according to claim 1, wherein said additive is brown to have a different taste.

3. The method according to claim 1, wherein said additive is matcha or coffee to have a different taste.

4. The method according to claim 1, wherein said additive is fruit to have a different taste.

5. A pearl tapioca dice structure, comprising a solid body, said solid body being a lump solid body formed by mixing and kneading ingredients such as glutinous rice flour, modified starch, maltose, and granulated sugar additives; at least one additive being made of at least one of brown sugar, matcha, and fruit such as strawberry, mango, pineapple, and said additive being uniformly mixed in said solid body structure in a certain proportion.
